(19) United States
(12) Patent Application Publication
(10) Pub. No.: US 2008/0212318 A1
(43) Pub. Date: Sep. 4, 2008

(54) Light Source Device for Components Inspection

(76) Inventor: Jin Feng Wang, GuangDong (CN)

Correspondence Address: SINORICA, LLC, 528 FALLSGROVE DRIVE, ROCKVILLE, MD, 20850, US

(21) Appl. No.: 11/995,531

(22) PCT Filed: Nov. 4, 2005
(86) PCT No.: PCT/CN05/01852

§ 371 Date: Jan. 12, 2008

(30) Foreign Application Priority Data
Jul. 13, 2005 (CN) 200520061048.X

(51) Int. Cl. F21V 9/00

(52) U.S. Cl. 362/231

(57) ABSTRACT

The present invention discloses a LED light source device for components inspection. The device has a white annular lamp and a blue annular lamp installed on a fixed blue-lamp ring, a green annular lamp installed on a fixed green-lamp ring and a red annular lamp installed on a fixed red-lamp ring. The fixed blue-lamp, green-lamp and red-lamp ring are being arranged from bottom to top respectively, and the white annular lamp is being positioned at the bottommost. In addition, a heat-dissipation ring is installed on the outskirt of the green annular lamp, along with heat-dissipation electric fans and a fixed light-source ring positioned on the top of the light source device. The present invention not only has the advantages of using four different light sources, including: a red light source, a green light source, a blue light source and a white light source, to illuminate inspected objects from different angles which allow camera to capture more information, but also increase the convenience for component inspection which in term provides higher assurance for components quality.

### BACKGROUND OF THE INVENTION

1. Field of the Invention

The present invention relates to a LED light source device for components inspection, which utilizes red, green, blue and white four different light sources to illuminate objects being inspected from different angles, whereby the camera can attain more information.

2. Description of the Related Art

Currently, all existing component inspection methods are inconvenient which directly effect the quality of components. Therefore, one objective of the present invention is to provide a production line light source device to solve the abovementioned problems.

### SUMMARY OF THE INVENTION

The objective of the present invention can be realized with the following measures: installing a white annular lamp and a blue annular lamp on a fixed blue-lamp ring; installing a green annular lamp on a fixed green-lamp ring; installing a red annular lamp on a fixed red-lamp ring; sequentially assembling the fixed blue-lamp, fixed green-lamp ring and fixed red-lamp ring bottom up with the white annular lamp in the bottommost position; installing a heat-dissipation ring in the outskirt of the green annular lamp; and installing heat-dissipation electric fans and a fixed light-source ring on the top.

The abovementioned annular lamps are bottom-up arranged in an order of the white annular lamp, blue annular lamp, green annular lamp and red annular lamp.

The angles of the lights of the abovementioned annular lamps with respect to the camera incrementally vary from the red annular lamp, the green annular lamp, the blue annular lamp to the white annular lamp.

Compared with the conventional technologies, the present invention has the advantages:
1. The present invention uses four different light sources, including: a red light source, a green light source, a blue light source and a white light source, to illuminate inspected objects from different angles, and the camera can thus attain more information;
2. The present invention can conveniences component inspection and assures the quality of components.

### BRIEF DESCRIPTION OF THE DRAWINGS

FIG. 1 is a diagram schematically showing the structure of a light source device according to the present invention;

FIG. 2 is a top view of a light source device according to the present invention;

FIG. 3 is a sectional view along Line A-A in FIG. 2; and

FIG. 4 is a diagram schematically showing one embodiment of the present invention.

### DETAILED DESCRIPTION OF THE INVENTION

The present invention will be described in accordance with the attached drawings which are embodiments of present invention.

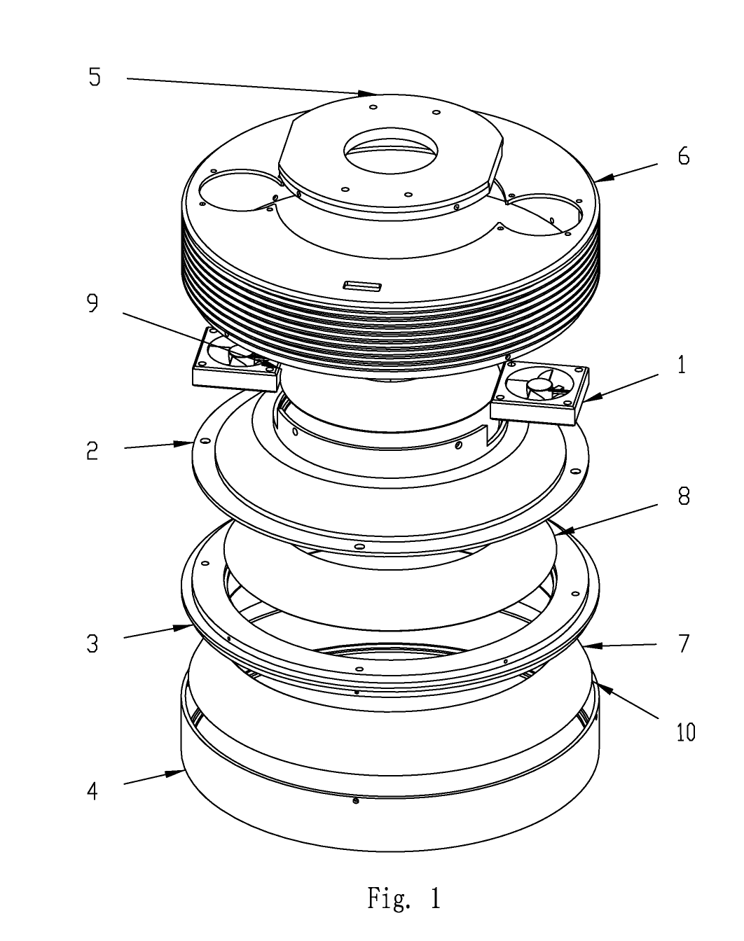

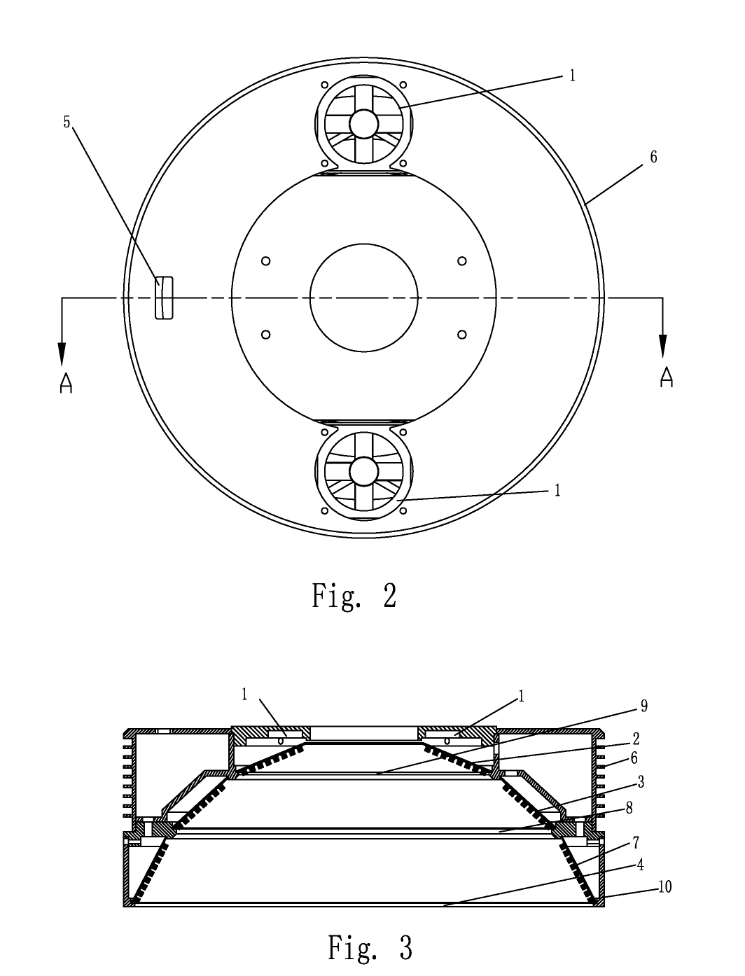

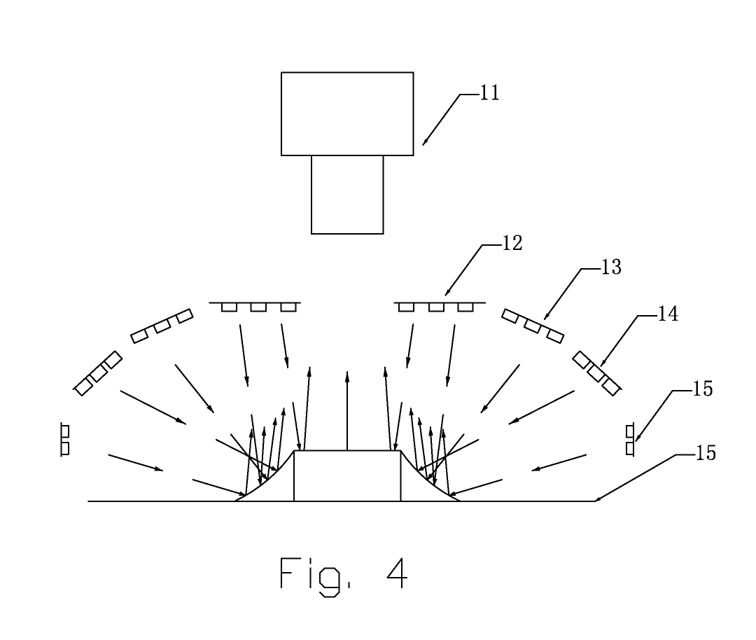

Refer to from FIG. 1 to FIG. 3. The present invention comprises: heat-dissipation electric fans 1, a fixed red-lamp ring 2, a fixed green-lamp ring 3, a fixed blue-lamp ring 4, a fixed light-source ring 5, a heat-dissipation ring 6, a blue annular lamp 7, a green annular lamp 8, a red annular lamp 9 and a white annular lamp 10. The white annular lamp 10 and blue annular lamp 7 are installed on the fixed blue-lamp ring 4. The fixed green-lamp ring 3 is arranged above the blue annular lamp 7, and the green annular lamp 8 is installed on the fixed green-lamp ring 3. The fixed red-lamp ring 2 is arranged above the green annular lamp 8, and the red annular lamp 9 is installed on the fixed red-lamp ring 2. The heat-dissipation ring 6 is installed in the perimeter of the green annular lamp 8. The heat-dissipation electric fans 1 and fixed light-source ring 5 are installed on the top of the present invention.

In the present invention, the annular lamps are top-down arranged in an order of the red annular lamp, green annular lamp, blue annular lamp and white annular lamp.

The angles of the lights of the abovementioned annular lamps are positioned with respect to the camera. The angle of the red annular lamp with respect to the camera is the smallest one; the angle of the green annular lamp with respect to the camera is greater than that of the red annular lamp; the angle of the blue annular lamp with respect to the camera is greater than that of the green annular lamp; and the angle of the white annular lamp with respect to the camera is the largest one.

Refer to FIG. 4 for the concept of the present invention.
1. There are four levels of light sources, including: a red LED lamp 12, a green LED lamp 13, a blue LED lamp 14 and a white LED lamp 15.
2. The abovementioned four different light sources illuminate inspected objects from different angles, and the camera 11 can thus capture more information.
3. The angle of the red light source with respect to the camera is the smallest one, and the red light is mainly reflected by the flat smooth surfaces, such as the lands and the component body 18. The angle of the green annular lamp with respect to the camera is greater than that of the red annular lamp, and the green light is mainly reflected by the slightly-inclined smooth surfaces, such as the solder, and the solder 17 near the component body 18. The angle of the blue annular lamp with respect to the camera is greater than that of the green annular lamp, and the blue light is mainly reflected by the steep smooth surfaces, such as the solder near the component body. The angle of the white annular lamp with respect to the camera is the largest one; most of the reflected white light does not enter the camera except little of the white light is scattered into the camera, such as the white light reflected from the PCB 16 and the component body. White light is primarily to enhance the brightness of the background.
4. From pictures captured by the camera with the present invention, it can be seen that they have vivid colors and higher contrast; especially the solder regions also have clear-cut gradations. The 3-D information captured by the camera with the present invention can provide sufficient information for assembled electronic products.

What is claimed is:

1. A light source device, characterized in
that said light source device comprises: heat-dissipation electric fans, a fixed red-lamp ring, a fixed green-lamp ring, a fixed blue-lamp ring, a fixed light-source ring, a heat-dissipation ring, a blue annular lamp, a green annular lamp, a red annular lamp and a white annular lamp, and
said white annular lamp and said blue annular lamp are installed on said fixed blue-lamp ring, and
said fixed green-lamp ring is arranged above said blue annular lamp,
and said green annular lamp is installed on said fixed green-lamp ring, and
said fixed red-lamp ring is arranged above said green annular lamp,
and said red annular lamp is installed on said fixed red-lamp ring, and
said heat-dissipation ring is installed in a perimeter of said green annular lamp, and
said heat-dissipation electric fans and said fixed light-source ring are installed on a top of said light source device.

2. The light source device according to claim 1, wherein said annular lamps are top-down arranged in an order of said red annular lamp, said green annular lamp, said blue annular lamp and said white annular lamp.

3. The light source device according to claim 1, wherein angles of lights of said annular lamps with respect to a camera incrementally vary from said red annular lamp, said green annular lamp, said blue annular lamp to said white annular lamp.

4. The light source device according to claim 2, wherein angles of lights of said annular lamps with respect to a camera incrementally vary from said red annular lamp, said green annular lamp, said blue annular lamp to said white annular lamp.
